(19) United States
(12) Patent Application Publication
(10) Pub. No.: US 2019/0308767 A1
(43) Pub. Date: Oct. 10, 2019

(54) BABY BOTTLE TWISTER

(71) Applicant: Pamela L. Sehrt, Reno, NV (US)

(72) Inventor: Pamela L. Sehrt, Reno, NV (US)

(21) Appl. No.: 16/353,446

(22) Filed: Mar. 14, 2019

Related U.S. Application Data
(60) Provisional application No. 62/761,857, filed on Apr. 10, 2018.

(51) Int. Cl. B65D 8/00; B65D 43/02; A61J 9/00

(52) U.S. Cl. CPC B65D 11/04; A61J 9/00; B65D 43/0231

(57) ABSTRACT

Embodiments of the disclosure pertain to improved baby bottle design that allows the bottle to be uncoupled for easier cleaning. The baby bottle can include a hollow tubular body including a top portion and a bottom portion; the top portion comprising a plurality of grooves on the interior of the tubular body to receive a threaded portion of the bottom portion; the bottom portion comprising a closed bottom. In various embodiments, the top portion of the tubular body can include multiple of grooves to couple a nipple and a collar to the hollow tubular body. In alternative embodiments, the baby bottle can include a hollow tubular body including a top portion and a bottom portion; the bottom portion comprising a plurality of grooves on the interior of the tubular body to receive a threaded portion of the top portion; the bottom portion comprising a closed bottom.

### CROSS-REFERENCES TO RELATED APPLICATIONS

This application claims priority to U.S. Provisional Patent Application Ser. No. 62/761,857, filed Apr. 10, 2018, entitled “Baby Bottle Opening in the Middle,” which is herein incorporated by reference in its entirety and for all purposes.

### FIELD

The described embodiments relate generally to baby products, specifically baby bottles.

### BACKGROUND

Currently available baby bottles are difficult to clean and sterilize. Baby bottles can be constructed on plastic. Plastic bottles, which are typically made of polypropylene, are lightweight and pose almost no risk of breaking. The American Academy of Pediatrics (AAP) recommends washing baby bottles after every feeding, using soap and hot water. Boiling the bottle is necessary to the safe cleaning of bottles, but the AAP notes that bottles should be allowed to dry completely to prevent the growth of bacteria that can thrive if leftover milk or water is allowed to linger in the bottle. Due to the tapered neck of a the baby bottle the bottom inside of the bottle can be difficult to reach and clean, even if using a bottle brush.

Some baby bottles can be washed using a dish washer. However, some bottles, especially larger bottles (e.g., 8 ounce bottles) will not fit within the upper tray in most home dishwashers due to the height. Placing the larger bottles in the lower portion of the dishwasher can result in the bottle being tossed around the dishwasher due to the water flow from the lower spray arm. The dirty dishwasher can collect in the bottle when not washed in an inverted, vertical position. This defeats the purpose of cleaning the bottles in the dishwasher.

### SUMMARY

Embodiments of the disclosure pertain to improved baby bottle design that allows the bottle to be uncoupled for easier cleaning.

In one aspect of the disclosure, the baby bottle can include a hollow tubular body including a top portion and a bottom portion; the top portion comprising a plurality of grooves on the interior of the tubular body to receive a threaded portion of the bottom portion; the bottom portion comprising a closed bottom. In various embodiments, the top portion of the tubular body can include multiple of grooves to couple a nipple and a collar to the hollow tubular body.

In various embodiments, the hollow tubular body is formed from a plastic material. In some embodiments the plastic material is a Bisphenol-A (BPA) free plastic material.

In various embodiments, the plastic material is temperature resistant. In some embodiments, the plastic material can withstand temperatures up to 170 degrees F. (75 degrees Celsius).

In some embodiments, the top portion of the tubular body can coupled with the bottom portion of the tubular body at midway between the top and the bottom of the tubular body when coupled.

In alternative embodiments, the baby bottle can include a hollow tubular body including a top portion and a bottom portion; the bottom portion comprising a plurality of grooves on the interior of the tubular body to receive a threaded portion of the top portion; the bottom portion comprising a closed bottom.

To better understand the nature and advantages of the present disclosure, reference can be made to the following description and the accompanying figures. It is to be understood, however, that each of the figures is provided for the purpose of illustration only and is not intended as a definition of the limits of the scope of the present disclosure. Also, as a general rule, and unless it is evident to the contrary from the description, where elements in different figures use identical reference numbers, the elements are generally either identical or at least similar in function or purpose.

### BRIEF DESCRIPTION OF THE DRAWINGS

The included drawings are for illustrative purposes and serve only to provide examples of possible structures and arrangements for the disclosed inventive apparatuses and methods for providing portable computing devices. These drawings in no way limit any changes in form and detail that may be made to the embodiments by one skilled in the art without departing from the spirit and scope of the disclosure. The embodiments can be readily understood by the following detailed description in conjunction with the accompanying drawings, wherein like reference numerals designate like structural elements, and in which:

FIG. 1 illustrates a simplified coupled perspective view of a baby bottle according to some embodiments of the disclosure.

FIG. 2 illustrates a uncoupled perspective view of a baby bottle according to some embodiments of the disclosure.

FIG. 3 illustrates a top perspective view of a baby bottle according to some embodiments of the disclosure.

### DETAILED DESCRIPTION

Embodiments of the disclosure pertain to bottles for feeding infants. The baby bottles can be filled with a liquid (e.g., milk or water). A nipple or cap can be fastened on to one end of the bottle. The bottle can include an upper portion and a lower portion where the upper portion and the lower portion are joined via a threaded coupling. Once uncoupled, the upper portion and lower portion can be washed and sterilized in the upper rack of a dishwasher without being tipped over.

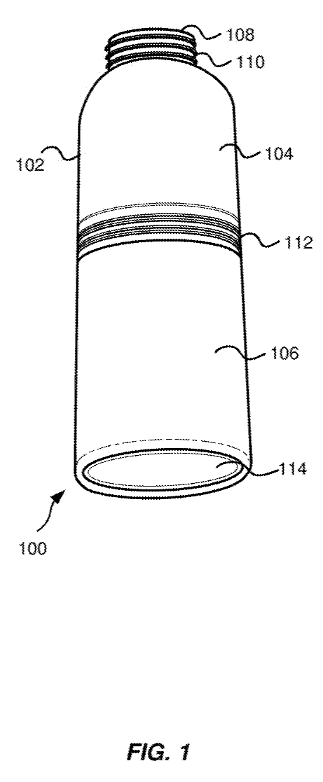

FIG. 1 illustrates a simplified coupled perspective view of a coupled baby bottle 100 according to some embodiments of the disclosure. In an embodiment, the baby bottle 100 include a hollow tubular body 102. In various embodiments, the hollow tubular body 102 includes an upper portion 104 and a lower portion 106. The upper portion 104 can taper down to an opening 108 in the top of the upper portion. In some embodiments one or more threads 110 can surround the opening 108. In various embodiments, a nipple can be coupled to the opening 108 via a threaded cap. In some embodiments, a cap can be coupled with the treaded cap to protect the nipple. In some embodiments, a threaded cap can be coupled with the opening 108. The lower portion 106 can include a sealed bottom at the end of the tubular body 102.

In various embodiments the hollow tubular body is formed from a plastic material. In some embodiments, the plastic material comprises Bisphenol-A (BPA) free plastic material. In some embodiments the plastic material is temperature resistant. In some embodiments, the plastic material can withstand temperatures up to 170 degrees F. (75 degrees Celsius).

In various embodiments, the hollow tubular body can be of various sizes including but not limited to a liquid capacity of four ounces, eight ounces, and nine ounces. A coupling can be formed at the midpoint of the bottle.

As shown in FIG. 1 the upper portion 104 can couple with the lower portion 106. In various embodiments, the lower portion 106 can include a series of threads 112 formed extending from the exterior surface of the tubular body. The inside of the upper portion 104 can include a plurality of grooves on the inside surface of the hollow tubular body 102. The plurality of grooves can be configured to receive the series of threads 112. Once the series of threads 112 are inserted into the plurality of grooves, the lower portion 106 can be coupled to the upper portion 108 by twisting the either the lower portion 106 or the upper portion 108 until tight. The coupling can form a watertight seal for the hollow tubular body 102.

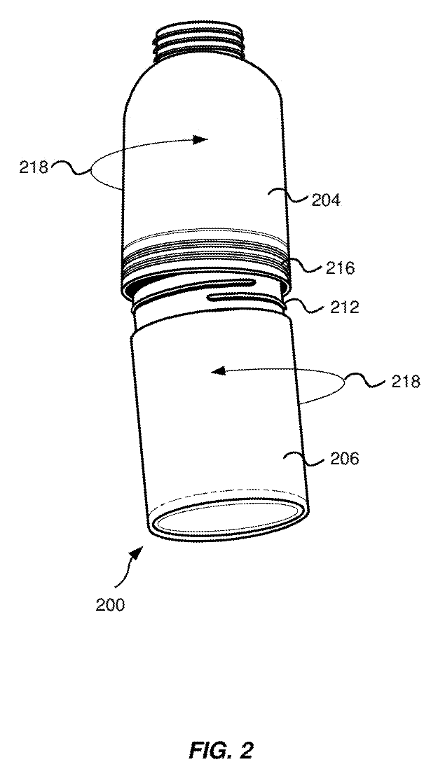

FIG. 2 illustrates a perspective view of an uncoupled baby bottle 200 according to some embodiments of the disclosure. FIG. 2 illustrates an upper portion 204 and a lower portion 206. FIG. 2 illustrates the series of threads 212 and the plurality of grooves 216. FIG. 2 illustrates arrows 218 indicating a direction of motion to twist the lower portion 206 into the upper portion 204 or twist the upper portion 204 onto the lower portion 206. The upper portion or the lower portion 206 can also be twisted in an opposite direction from the arrows 218 to uncoupled the upper portion 204 from the lower portion 206.

In an alternative embodiment, the upper portion 204 can a series of threads 212 and the lower portion 206 can include a plurality of grooves 216. In the alternate embodiment, series of threads 212 of the upper portion 204 can be twisted into the plurality of grooves 216 of the lower portion 206.

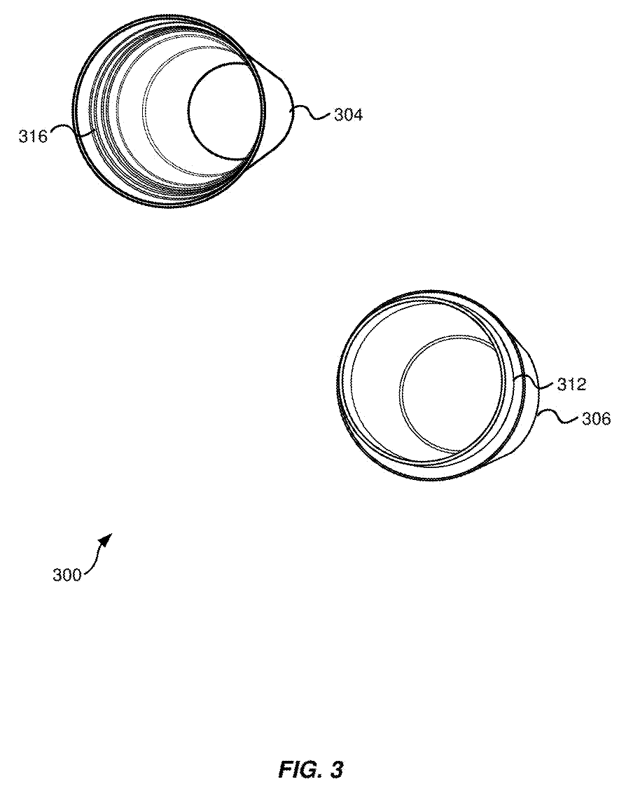

FIG. 3 illustrates a top perspective view of a baby bottle 300 according to some embodiments of the disclosure. FIG. 3 illustrates a top portion 304 uncoupled from the lower portion 306. The upper portion 304 can include a plurality of grooves 316. The lower portion 306 can include a series of threads 312. When uncoupled as depicted in FIG. 3, the upper portion 304 and lower portion 306 can be placed in the upper rack of a dishwasher normally used for cleaning glasses, mugs, or cups.

Representative applications of apparatuses and methods according to the presently described embodiments are provided in this section. These examples are being provided solely to add context and aid in the understanding of the described embodiments. It can thus be apparent to one skilled in the art that the presently described embodiments can be practiced without some or all of these specific details. In other instances, well known process steps have not been described in detail in order to avoid unnecessarily obscuring the presently described embodiments. Other applications are possible, such that the following examples are not as limiting.

Representative applications of apparatuses and methods according to the presently described embodiments are provided in this section. These examples are being provided solely to add context and aid in the understanding of the described embodiments. It can thus be apparent to one skilled in the art that the presently described embodiments can be practiced without some or all of these specific details. For example, in some embodiments, the case can store more than two earbuds. In some embodiments, the housing may appear different as additional features are added.

In the foregoing specification, embodiments of the disclosure have been described with reference to numerous specific details that can vary from implementation to implementation. The specification and drawings are, accordingly, to be regarded in an illustrative rather than a restrictive sense. The sole and exclusive indicator of the scope of the disclosure, and what can be intended by the applicants to be the scope of the disclosure, is the literal and equivalent scope of the set of claims that issue from this application, in the specific form in which such claims issue, including any subsequent correction. The specific details of particular embodiments can be combined in any suitable manner without departing from the spirit and scope of embodiments of the disclosure.

Although the foregoing disclosure has been described in detail by way of illustration and example for purposes of clarity and understanding, it can be recognized that the above described devices may be embodied in numerous other specific variations and embodiments without departing from the spirit or essential characteristics of the devices. Certain changes and modifications may be practiced, and it is understood that the disclosure is not to be limited by the foregoing details, but rather is to be defined by the scope of the appended claims.

Additionally, spatially relative terms, such as “bottom” or “top” and the like can be used to describe an element and/or feature's relationship to another element(s) and/or feature(s) as, for example, illustrated in the figures. It can be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

What is claimed is:

1. A baby bottle comprising:
a hollow tubular body including a top portion and a bottom portion; the top portion comprising a plurality of grooves on the interior of the tubular body to receive a threaded portion of the bottom portion; the bottom portion comprising a closed bottom.

2. The baby bottle of claim 1, wherein the top portion of the tubular body comprises a plurality of grooves to couple a nipple and a collar to the hollow tubular body.

3. The baby bottle of claim 1, wherein the hollow tubular body comprises Bisphenol-A free plastic material.

4. The baby bottle of claim 3, wherein the plastic material can withstand temperatures up to 170 degrees F. (75 degrees Celsius).

5. The baby bottle of claim 1, wherein the top portion of the tubular body is coupled with the bottom portion of the tubular body at midway between the top and the bottom of the tubular body when coupled.

6. A baby bottle comprising:
a hollow tubular body including a top portion and a bottom portion; the bottom portion comprising a plurality of grooves on the interior of the tubular body to receive a threaded portion of the top portion; the bottom portion comprising a closed bottom.

7. The baby bottle of claim 6, wherein the top portion of the tubular body comprises a plurality of grooves to couple a nipple and a collar to the hollow tubular body.

8. The baby bottle of claim 6, wherein the hollow tubular body comprises Bisphenol-A free plastic material.

9. The baby bottle of claim 8, wherein the plastic material can withstand temperatures up to 170 degrees F. (75 degrees Celsius).

10. The baby bottle of claim 6, wherein the top portion of the tubular body is coupled with the bottom portion of the tubular body at midway between the top and the bottom of the tubular body when coupled.
